(19) United States
(12) Patent Application Publication
(10) Pub. No.: US 2024/0346880 A1
(43) Pub. Date: Oct. 17, 2024

(54) WIN POOLING

(71) Applicant: IGT, Las Vegas, NV (US)

(72) Inventors: Robert Silva, Reno, NV (US); Dwayne Nelson, Las Vegas, NV (US)

(21) Appl. No.: 18/134,405

(22) Filed: Apr. 13, 2023

(51) Int. Cl. G07F 17/32; G06Q 30/0279

(52) U.S. Cl. CPC G07F 17/3239; G06Q 30/0279; G07F 17/3255; G07F 17/3274

(57) ABSTRACT

Embodiments of the present disclosure are directed to managing player pools, i.e., competitive groups of gamblers. According to embodiments described herein, players can join player pools and compete against each other. The winning player pool can receive some award or recognition. In one embodiment players from different casinos or gaming venues can compete against each other. That is, each casino or gaming venue can form a player pool of players. The player pools can be ranked by amount won, amount wagered, amount won on a feature (bonus), amount won on a category, e.g., flush, royal flush, etc., and/or other factors. As members of the player pools play, their contribution to the player pool can be recorded. For example, player loyalty accounts can be used to track the contributions and know which members are part of the player pool.

### BACKGROUND

Embodiments of the present disclosure relate generally to managing game play on electronic gaming systems and more particularly to managing player pools for users of electronic gaming systems.

People often visit casinos or other gaming venues as part of a social event or activity. For example, a married couple or members of a family may visit Las Vegas or other location to play gambling games at a casino or other venue. In other cases, members of a tour group, participants in a conventions, or other similar groups may also visit such locations and gamble any of a variety of games. To increase an incentive to play such games and thereby increase potential revenues to the casino or gaming venue, there is a need for methods and systems that encourage the social aspects of gaming.

### BRIEF SUMMARY

According to one embodiment, a method for managing a plurality of player pools can comprise monitoring gaming activity of a plurality of members of a first player pool of the plurality of player pools and gaming activity of a plurality of members of a second player pool of the plurality of player pools. In some cases, the plurality of members of the first player pool can be physically present in a first gaming venue and the plurality of members of the second player pool are physically present in a second gaming venue. In other cases, the plurality of members of the first player pool and the plurality of members of the second player pool can be physically present in the same gaming venue.

The first player pool and the second player pool can be ranked based on the monitored gaming activity of the plurality of members of the first player pool and the monitored gaming activity of the plurality of members of the second player pool. For example, ranking the first player pool and the second player pool based on the monitored gaming activity of the plurality of members of the first player pool and the monitored gaming activity of the plurality of members of the second player pool can be based on an overall amount wagered by the plurality of members of the first player pool and the plurality of members of the second player pool. In another example, ranking the first player pool and the second player pool based on the monitored gaming activity of the plurality of members of the first player pool and the monitored gaming activity of the plurality of members of the second player pool can be based on an overall win amount by the plurality of members of the first player pool and the plurality of members of the second player pool. Ranking the first player pool and the second player pool based on the monitored gaming activity of the plurality of members of the first player pool and the monitored gaming activity of the plurality of members of the second player pool can be, in another example, based on an amount of feature bonuses received by the plurality of members of the first player pool and the plurality of members of the second player pool. In still another example, ranking the first player pool and the second player pool based on the monitored gaming activity of the plurality of members of the first player pool and the monitored gaming activity of the plurality of members of the second player pool can be based on an amount of category wins by the plurality of members of the first player pool and the plurality of members of the second player pool.

An occurrence of a pre-defined event can be detected. In response to detecting the occurrence of the pre-defined event, an award can be assigned to at least one member of the first player pool or the second player pool based on the ranking of the first player pool and the second player pool.

According to another embodiment, a system can comprise a processor and a memory coupled with and readable by the processor. The memory can store therein a set of instructions which, when executed by the processor, causes the processor to monitor gaming activity of a plurality of members of a first player pool of the plurality of player pools and gaming activity of a plurality of members of a second player pool of the plurality of player pools. The first player pool and the second player pool can be ranked based on the monitored gaming activity of the plurality of members of the first player pool and the monitored gaming activity of the plurality of members of the second player pool. An occurrence of a pre-defined event can be detected and, in response to detecting the occurrence of the pre-defined event, an award can be assigned to at least one member of the first player pool or the second player pool based on the ranking of the first player pool and the second player pool.

For example, assigning the award to at least one member of the first player pool or the second player pool based on the ranking of the first player pool and the second player pool can comprise one or more of awarding money to at least one member of the first player pool or the second player pool based on the ranking of the first player pool and the second player pool, awarding loyalty points to at least one member of the first player pool or the second player pool based on the ranking of the first player pool and the second player pool, awarding gaming venue services to at least one member of the first player pool or the second player pool based on the ranking of the first player pool and the second player pool, etc. Assigning the award to at least one member of the first player pool or the second player pool based on the ranking of the first player pool and the second player pool can comprise assigning an award to one member or each member of the first player pool or the second player pool based on the ranking of the first player pool and the second player pool. The award can be fixed at the initiation of the first player pool and the second player pool or can be variable during the monitoring of the gaming activity of the plurality of members of the first player pool and the monitoring of the gaming activity of the plurality of members of the second player pool. In some cases, the award can be a contribution to a charity. For example, the charity can be selected by at least one member of the first player pool or the second player pool.

According to yet another embodiment, a non-transitory, computer-readable medium can comprise a set of instructions stored therein which, when executed by a processor, causes the processor to monitor gaming activity of a plurality of members of a first player pool of the plurality of player pools and gaming activity of a plurality of members of a second player pool of the plurality of player pools. In some cases, the instructions can further cause the processor to send an electronic message promoting gaming activity to mobile devices of the plurality of members of the first player pool and the plurality of members of the second player pool. Additionally, or alternatively, the instructions can further cause the processor to monitor gaming activity of a member of the first player pool prior to assigning the member to the first player pool and wherein the member is assigned to the first player pool in response to the monitored gaming activity of the member exceeding a pre-determined amount.

The instructions can further cause the processor to rank the first player pool and the second player pool based on the monitored gaming activity of the plurality of members of the first player pool and the monitored gaming activity of the plurality of members of the second player pool and detect an occurrence of a pre-defined event. In response to detecting the occurrence of the pre-defined event, the instructions can cause the processor to assign an award to at least one member of the first player pool or the second player pool based on the ranking of the first player pool and the second player pool.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary environment for managing player pools according to one embodiment of the present disclosure.

FIG. 2 is a block diagram illustrating additional details of an exemplary pool management system according to one embodiment of the present disclosure.

FIG. 3 is a flowchart illustrating an exemplary process for managing a player pool according to one embodiment of the present disclosure.

FIG. 4 is a flowchart illustrating an exemplary process for managing a plurality of player pools according to one embodiment of the present disclosure.

FIG. 5 is a flowchart illustrating an exemplary process for managing a plurality of player pools according to another embodiment of the present disclosure.

### DETAILED DESCRIPTION

Embodiments of the present disclosure are directed to managing player pools, i.e., competitive groups of gamblers. According to embodiments described herein, players can join groups and compete against each other. The winning group can receive some award or recognition. In one embodiment players from different casinos or gaming venues can compete against each other. That is, each casino or gaming venue can form a group of players. The groups can be ranked by amount won, amount wagered, amount won on a feature (bonus), amount won on a category, e.g., flush, royal flush, etc., and/or other factors. As members of the groups play, their contribution to the group can be recorded. For example, player loyalty accounts can be used to track the contributions and know which members are part of the group.

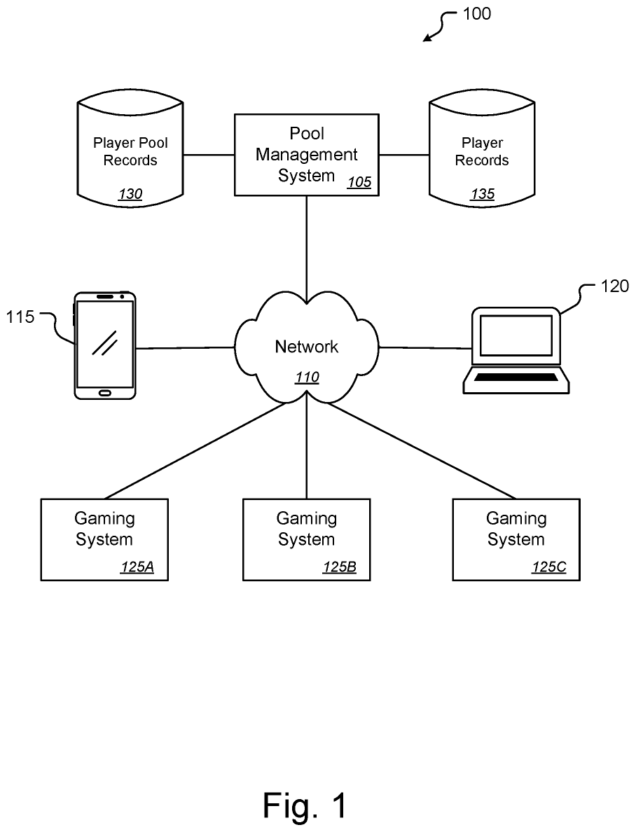

FIG. 1 is a block diagram illustrating an exemplary environment for managing player pools according to one embodiment of the present disclosure. As illustrated in this example, the environment 100 can comprise a pool management system 105 which can comprise one or more servers and/or other computing devices or systems within a casino or other gaming venue. The pool management system 105 can be communicatively coupled with one or more wired and/or wireless communications networks 110. According to one embodiment, a mobile device 115 such as a cellular phone, tablet, or other portable computing device of a player visiting the casino or other gaming venue can also be communicatively coupled with the pool management system 105 through the communications network 110. Through the mobile device 115, request to initiate and/or configure a player pool, view existing player pools, join a player pool, make a contribution to a player pool etc. Additionally, or alternatively, a kiosk system 120 or other computing device or system can also be communicatively coupled with the pool management system 105 through the communications network 110 and can be used by players visiting the casino or other gaming venue to request to initiate and/or configure a player pool, view existing player pools, join a player pool, make a contribution to a player pool etc. In some embodiments a player can join multiple player pools to have multiple chances at winning. This ability and/or the number of simultaneous pools possible can be configured by the pool management system 105.

A number of gaming systems 125A-125C can also be communicatively coupled with the communications network 110. These gaming systems 125A-125C can include, but are not limited to, and any of a variety of known Electronic Gaming Machines (EGMs), Electronic Table Games (ETGs), and/or similar gaming systems found in casinos and other gaming venues. Generally speaking, through the mobile device 115 or kiosk system 120, a player can establish and configure one or more player pools in which a number of players are contributing to the pool, cooperatively playing at one or more gaming systems 125A-125C, and/or sharing the winnings or yield of playing sessions. For example, players can register in a player pool managed by the pool management system 105 and add funds to the player pool through the kiosk system 120 or a mobile account associated with the mobile device 115 of the player to dedicate a certain amount of money to be played at the location. In another example, players can participate in a player pool which accumulates winnings from games played by various players of difference gaming systems 125A-125C and splits or shares those winnings between some or all of the players in the player pool depending on how the player pool is configured. In either case, the player pool can be defined by and managed according to a set of player pool records 130 maintained by the pool management system 105.

According to embodiments described herein, players can join player pools and compete against each other. The winning player pool can receive some award or recognition. In one embodiment players from different casinos or gaming venues can compete against each other. That is, each casino or gaming venue can form a player pool. The player pools can be ranked by amount won, amount wagered, amount won on a feature (bonus), amount won on a category, e.g., flush, royal flush, etc., and/or other factors. As members of the player pools play, their contribution to the player pool can be recorded. For example, player loyalty accounts and/or other player records 135 can be used to track the contributions and know which members are part of the player pool. In one embodiment the player pools can be maintained to have the same number of players, such as 100. In other embodiments, the player pools can have a range or players, such as 100-125. In yet another embodiment, the player pools can have any number of players. In some cases, once a player is in a player pool they may be encouraged to stay. For example, an award amount available to that player may be increased if the player stays in the player pool rather than leaving.

Once the player(s) have joined a player pool and logged in, entered a casino or gaming venue, carded into a gaming system 125A, etc., the pool management system 105 can identify the player(s) and therefore know which player pools, if any, the player has joined. As the player wagers and wins at the gaming system 125A, the gaming system 125A can notify the pool management system 105 which can track the wagers and wins of the player and add them to the player pool.

In one embodiment all players in the casino and casino loyalty club can be members of the player pool. If all players are contributing to the casino's player pool, the casino does not need players to be carded in, in order to track the contributions to the player pool. Once a competition is started, player pools between casinos or gaming venues can compete and after some period of time the player pool with the highest ranking can be considered the winner. In another embodiment, the competition can be conducted in brackets, like a sports tournaments. In the bracket system, each tier can be a competition over some period of time, such as a day or week. The winners at each tier can proceed to the next tier until there is only one winning player pool/casino.

The winning, i.e., highest ranked, player pool of the competition could be awarded prizes, money, points, meals, shows, etc. In one embodiment, the prize can be split evenly amongst the players in the player pool while in another the prize can be split according to the contribution of each player to the winning player pool. In one embodiment, the prize for winning is determined up front as one unique prize, such as $1,000. In one embodiment, each casino presents its own prize. For example, Casino 1 could offer $1,000 if it is player pool wins, while Casino 2 could offer $2,000 if it is player pool wins. In one embodiment, the prize can be fixed at the start of the competition. In another embodiment, the casinos can adjust the prize during the competition. For example, Casino 1 can offer a prize of $1,000. The Casino 1 player pool does well and gets near the winning position, so Casino 1 increases the prize from $1,000 to $5,000 in order to incentivize players at its property to play more and win. The casino can increase the player points for player pool contributions or for everyone during this period. In one embodiment the prize can be a percentage of the wagers or wins of one or more player pools, such as 0.1% of the wager. This can make the competition a cross-property, event-based progressive. In one embodiment, the prize can be a contribution to a charity. For example, each player pool/casino can choose a charity and the winning player pool's charity can receive the prize. In another embodiment, the player pool can receive the prize and the charity receives an award, such as the casino matching the player pool prize as a contribution to the charity. According to one embodiment, played in a player pool can contribute a percentage. Each player can also pick a charity. If that player wins the player pool, the award can go to their charity. The win can be triggered on some threshold or some win category.

Embodiments have been described as casino vs casino competition, but the player pools could be formed within one casino or gaming venue. In such cases, players within a given casino or gaming venue could join player pools and compete against each other over a period of weeks or months. This can give the casino the opportunity to award additional or bonus player loyalty points to players and encourages them to return to the casino to continue the competition. For example, players can join the player pool from a gaming system 125A, a kiosk 120 such as a player loyalty desk, or the casino player loyalty app on their mobile device 115. Once they join, the casino can use the app or texting to inform the player of the event and encourage then to return to the casino to wager. “We are beating Casino 2. Keep it up! Remember, you get 2× points this week during the competition!”.

In some embodiments, players may earn or purchase the entry into the player pool. In one example, players may be expected to pay $10 to enter. In another example, a player might use player loyalty points to enter. In another example, a player may be expected to win a royal flush to enter. In another example, a player can be entered after betting a minimum amount within a specified period.

According to one embodiment, a current leader of a player pool can be allowed to determine or select a current theme, denomination, and/or other configuration for that player pool. In such cases, the configuration can be maintained until there is a new current leader of the player pool who can then elect to change some or all of the available configuration options.

According to one embodiment, an amount of a win by a player in a player pool can be added to the player pool. Another player may then use the amount available in the player pool to place sports wagers or buy lottery tickets. In such cases, if the sports wagers or lottery tickets win, the amount of that win can be awarded to the contributors to the pool.

In some cases, a player pool or individual players within the player pool can have a target or goal such as a royal flush, slot bonus, etc. When the player pool starts, players in the player pool can attempt to complete these goals so that the player pool wins. In such cases, a frenzy at the end can happen when one item is left on the list.

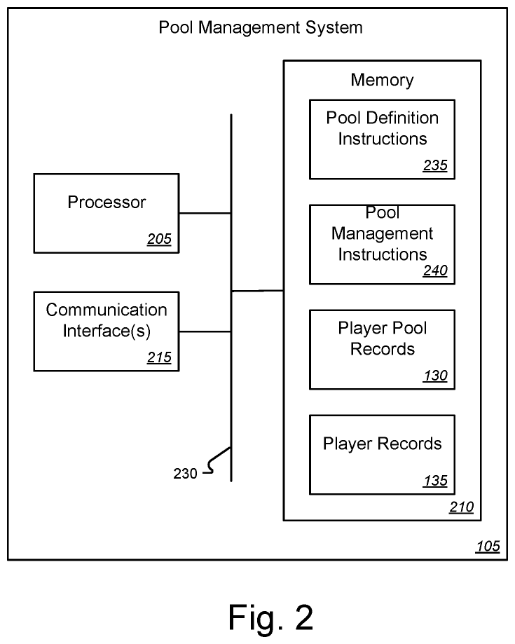

FIG. 2 is a block diagram illustrating additional details of an exemplary pool management system according to one embodiment of the present disclosure. As illustrated in this example, a pool management system 105 can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the pool management system 105 as described herein.

The memory 210 can be coupled with and readable by the processor 205 via a communications bus 230. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interfaces 215 via the communications bus 230. The communication interfaces 215 can comprise, for example, a Bluetooth, WiFi, cellular, and/or other type of wireless communications interface.

The memory 210 can store therein sets of instructions which, when executed by the processor 205, cause the processor 205 to manage player pools as described herein. For example, the memory 210 can store a set of pool definition instructions 235 which, when executed by the processor 205, can cause the processor 205 to generate or define a player pool. Generally speaking, the pool definition instructions 235 can cause the processor 205 to maintain a set of player pool records 130. The player pool records 130 can define configuration and/or membership in a player pool, current status or other information for the player pool, etc.

The memory 210 can also store therein a set of player pool management instructions 240 which, when executed by the processor 205, can cause the processor 205 to identify a player, e.g., when entering a gaming venue or area of a gaming venue, when initiating an electronic game on a gaming system 125A, etc., using a player ID, loyalty account number, biometric information, by identifying a mobile device of the player, etc. An electronic game can then be conducted by the gaming system 125A with the player. The player pool management instructions 240 can further cause the processor 205 to update the player pool records based on the electronic game being conducted, e.g., to record gamin interaction information, events within the electronic game, etc.

The player pool management instructions 240 can further cause the processor 205 to monitor gaming activity of a plurality of members of a first player pool of the plurality of player pools and monitor gaming activity of a plurality of members of a second player pool of the plurality of player pools. In some cases, as noted above, the plurality of members of the first player pool can be physically present in a first gaming venue and the plurality of members of the second player pool are physically present in a second gaming venue. In other cases, the plurality of members of the first player pool and the plurality of members of the second player pool can be physically present in the same gaming venue.

The player pool management instructions 240 can further cause the processor 205 to rank the first player pool and the second player pool based on the monitored gaming activity of the plurality of members of the first player pool and the monitored gaming activity of the plurality of members of the second player pool. For example, ranking the first player pool and the second player pool based on the monitored gaming activity of the plurality of members of the first player pool and the monitored gaming activity of the plurality of members of the second player pool can be based on an overall amount wagered by the plurality of members of the first player pool and the plurality of members of the second player pool. In another example, ranking the first player pool and the second player pool based on the monitored gaming activity of the plurality of members of the first player pool and the monitored gaming activity of the plurality of members of the second player pool can be based on an overall win amount by the plurality of members of the first player pool and the plurality of members of the second player pool. Ranking the first player pool and the second player pool based on the monitored gaming activity of the plurality of members of the first player pool and the monitored gaming activity of the plurality of members of the second player pool can be, in another example, based on an amount of feature bonuses received by the plurality of members of the first player pool and the plurality of members of the second player pool. In still another example, ranking the first player pool and the second player pool based on the monitored gaming activity of the plurality of members of the first player pool and the monitored gaming activity of the plurality of members of the second player pool can be based on an amount of category wins by the plurality of members of the first player pool and the plurality of members of the second player pool.

The player pool management instructions 240 can further cause the processor 205 to detect an occurrence of a pre-defined event, e.g., a win event of other event in an electronic game being conducted with one of the members of one of the player pools. In response to detecting the occurrence of the pre-defined event, the player pool management instructions 240 can further cause the processor 205 to assign an award to at least one member of the first player pool or the second player pool based on the ranking of the first player pool and the second player pool. That is, when a winning or other identified event is detected, one or more members of the higher ranked pool can be awarded.

For example, assigning the award to at least one member of the first player pool or the second player pool based on the ranking of the first player pool and the second player pool can comprise updating a player record 135 associated with the one or more players to indicate one or more of awarding money to at least one member of the first player pool or the second player pool based on the ranking of the first player pool and the second player pool, awarding loyalty points to at least one member of the first player pool or the second player pool based on the ranking of the first player pool and the second player pool, awarding gaming venue services to at least one member of the first player pool or the second player pool based on the ranking of the first player pool and the second player pool, etc. Assigning the award to at least one member of the first player pool or the second player pool based on the ranking of the first player pool and the second player pool can comprise assigning an award to one member or each member of the first player pool or the second player pool based on the ranking of the first player pool and the second player pool. The award can be fixed at the initiation of the first player pool and the second player pool or can be variable during the monitoring of the gaming activity of the plurality of members of the first player pool and the monitoring of the gaming activity of the plurality of members of the second player pool. In some cases, the award can be a contribution to a charity. For example, the charity can be selected by at least one member of the first player pool or the second player pool.

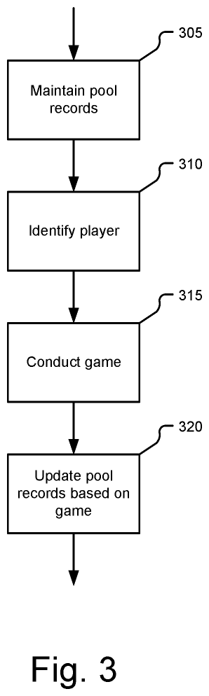

FIG. 3 is a flowchart illustrating an exemplary process for managing a player pool according to one embodiment of the present disclosure. As illustrated in this example, the process for managing a given player pool can begin with maintaining 305 a set of player pool records 130. As described above, the player pool records 130 can define configuration and/or membership in a player pool, current status or other information for the player pool, etc. A player can be identified 310, e.g., when entering a gaming venue or area of a gaming venue, when initiating an electronic game on a gaming system 125A, etc., using a player ID, loyalty account number, biometric information, by identifying a mobile device of the player, etc. An electronic game can then be conducted 315 by the gaming system 125A with the player. The player pool records 130 can be updated 320 based on the electronic game being conducted 315, e.g., to record gamin interaction information, events within the electronic game, etc. as described above.

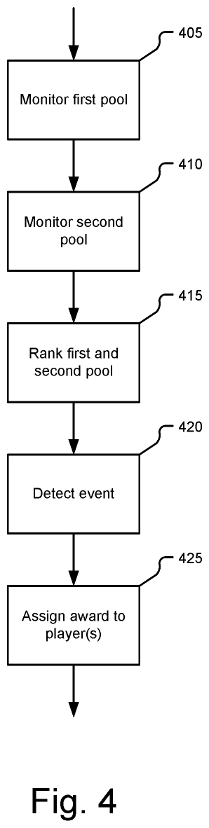

FIG. 4 is a flowchart illustrating an exemplary process for managing a plurality of player pools according to one embodiment of the present disclosure. As illustrated in this example, managing a plurality of player pools can comprise monitoring 405 gaming activity of a plurality of members of a first player pool of the plurality of player pools and monitoring 410 gaming activity of a plurality of members of a second player pool of the plurality of player pools. In some cases, as noted above, the plurality of members of the first player pool can be physically present in a first gaming venue and the plurality of members of the second player pool are physically present in a second gaming venue. In other cases, the plurality of members of the first player pool and the plurality of members of the second player pool can be physically present in the same gaming venue.

The first player pool and the second player pool can be ranked 415 based on the monitored 405 gaming activity of the plurality of members of the first player pool and the monitored 410 gaming activity of the plurality of members of the second player pool. For example, ranking 415 the first player pool and the second player pool based on the monitored 405 gaming activity of the plurality of members of the first player pool and the monitored 410 gaming activity of the plurality of members of the second player pool can be based on an overall amount wagered by the plurality of members of the first player pool and the plurality of members of the second player pool. In another example, ranking 415 the first player pool and the second player pool based on the monitored 405 gaming activity of the plurality of members of the first player pool and the monitored 410 gaming activity of the plurality of members of the second player pool can be based on an overall win amount by the plurality of members of the first player pool and the plurality of members of the second player pool. Ranking 415 the first player pool and the second player pool based on the monitored 405 gaming activity of the plurality of members of the first player pool and the monitored 410 gaming activity of the plurality of members of the second player pool can be, in another example, based on an amount of feature bonuses received by the plurality of members of the first player pool and the plurality of members of the second player pool. In still another example, ranking 415 the first player pool and the second player pool based on the monitored 405 gaming activity of the plurality of members of the first player pool and the monitored 410 gaming activity of the plurality of members of the second player pool can be based on an amount of category wins by the plurality of members of the first player pool and the plurality of members of the second player pool.

An occurrence of a pre-defined event, e.g., a win event of other event in an electronic game being conducted with one of the members of one of the player pools can be detected 420. In response to detecting 420 the occurrence of the pre-defined event, an award can be assigned 425 to at least one member of the first player pool or the second player pool based on the ranking of the first player pool and the second player pool. That is, when a winning or other identified event is detected, one or more members of the higher ranked pool can be awarded.

For example, assigning 425 the award to at least one member of the first player pool or the second player pool based on the ranking of the first player pool and the second player pool can comprise updating a player record 135 associated with the one or more players to indicate one or more of awarding money to at least one member of the first player pool or the second player pool based on the ranking of the first player pool and the second player pool, awarding loyalty points to at least one member of the first player pool or the second player pool based on the ranking of the first player pool and the second player pool, awarding gaming venue services to at least one member of the first player pool or the second player pool based on the ranking of the first player pool and the second player pool, etc. Assigning 425 the award to at least one member of the first player pool or the second player pool based on the ranking of the first player pool and the second player pool can comprise assigning an award to one member or each member of the first player pool or the second player pool based on the ranking of the first player pool and the second player pool. The award can be fixed at the initiation of the first player pool and the second player pool or can be variable during the monitoring of the gaming activity of the plurality of members of the first player pool and the monitoring of the gaming activity of the plurality of members of the second player pool. In some cases, the award can be a contribution to a charity. For example, the charity can be selected by at least one member of the first player pool or the second player pool.

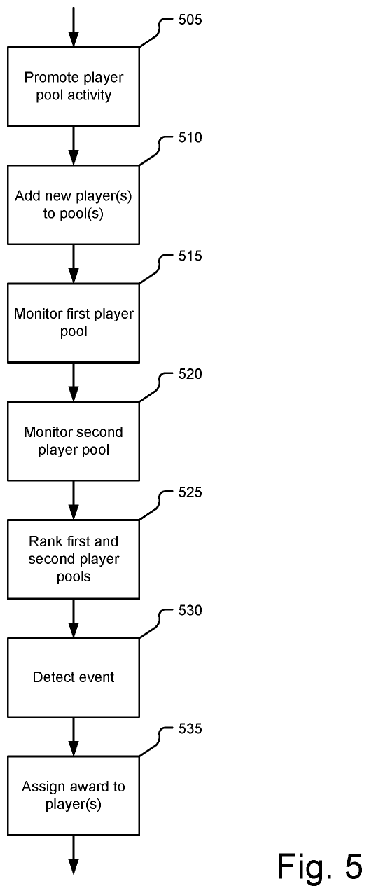

FIG. 5 is a flowchart illustrating an exemplary process for managing a plurality of player pools according to another embodiment of the present disclosure. As illustrated in this example, the process can include promoting 505 player pool activity. For example, promoting 505 player pool activity can include sending an electronic message, e.g., text message, email, etc., to mobile devices of the members of the pools to encourage gaming activity. Additionally, or alternatively, the process can include adding 510 new players to any or all pools. For example, adding 510 players can include monitoring gaming activity prior to assigning a member to a pool. The member can be assigned to the player pool, for example, in response to the monitored gaming activity of the member exceeding a pre-determined amount.

As described above, the process can also include monitoring 515 gaming activity of a plurality of members of a first player pool of the plurality of player pools and monitoring 520 gaming activity of a plurality of members of a second player pool of the plurality of player pools. The first player pool and the second player pool can be ranked 525 based on the monitored 515 gaming activity of the plurality of members of the first player pool and the monitored 520 gaming activity of the plurality of members of the second player pool. An occurrence of a pre-defined event, e.g., a win event of other event in an electronic game being conducted with one of the members of one of the player pools can be detected 530. In response to detecting 530 the occurrence of the pre-defined event, an award can be assigned 535 to at least one member of the first player pool or the second player pool based on the ranking of the first player pool and the second player pool.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Pat. No. 8,764,566, entitled “Internet Remote Game Server,” and U.S. Pat. No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A method for managing a plurality of player pools, the method comprising:
monitoring, by the gaming venue pool management system, gaming activity of a plurality of members of a first player pool of the plurality of player pools;
monitoring, by the gaming venue pool management system, gaming activity of a plurality of members of a second player pool of the plurality of player pools;
ranking, by the gaming venue pool management system, the first player pool and the second player pool based on the monitored gaming activity of the plurality of members of the first player pool and the monitored gaming activity of the plurality of members of the second player pool;
detecting, by the gaming venue pool management system, an occurrence of a pre-defined event; and
in response to detecting the occurrence of the pre-defined event, assigning, by the gaming venue system, an award to at least one member of the first player pool or the second player pool based on the ranking of the first player pool and the second player pool.

2. The method of claim 1, wherein the plurality of members of the first player pool are physically present in a first gaming venue and the plurality of members of the second player pool are physically present in a second gaming venue.

3. The method of claim 1, wherein the plurality of members of the first player pool and the plurality of members of the second player pool are physically present in the same gaming venue.

4. The method of claim 1, wherein ranking the first player pool and the second player pool based on the monitored gaming activity of the plurality of members of the first player pool and the monitored gaming activity of the plurality of members of the second player pool is based on an overall amount wagered by the plurality of members of the first player pool and the plurality of members of the second player pool.

5. The method of claim 1, wherein ranking the first player pool and the second player pool based on the monitored gaming activity of the plurality of members of the first player pool and the monitored gaming activity of the plurality of members of the second player pool is based on an overall win amount by the plurality of members of the first player pool and the plurality of members of the second player pool.

6. The method of claim 1, wherein ranking the first player pool and the second player pool based on the monitored gaming activity of the plurality of members of the first player pool and the monitored gaming activity of the plurality of members of the second player pool is based on an amount of feature bonuses received by the plurality of members of the first player pool and the plurality of members of the second player pool.

7. The method of claim 1, wherein ranking the first player pool and the second player pool based on the monitored gaming activity of the plurality of members of the first player pool and the monitored gaming activity of the plurality of members of the second player pool is based on an amount of category wins by the plurality of members of the first player pool and the plurality of members of the second player pool.

8. A system comprising:
a processor; and
a memory coupled with and readable by the processor and storing therein a set of instructions which, when executed by the processor, causes the processor to:
monitor gaming activity of a plurality of members of a first player pool of the plurality of player pools;
monitor gaming activity of a plurality of members of a second player pool of the plurality of player pools;
rank the first player pool and the second player pool based on the monitored gaming activity of the plurality of members of the first player pool and the monitored gaming activity of the plurality of members of the second player pool;
detect an occurrence of a pre-defined event; and
in response to detecting the occurrence of the pre-defined event, assign an award to at least one member of the first player pool or the second player pool based on the ranking of the first player pool and the second player pool.

9. The system of claim 8, wherein assigning the award to at least one member of the first player pool or the second player pool based on the ranking of the first player pool and the second player pool comprises awarding money to at least one member of the first player pool or the second player pool based on the ranking of the first player pool and the second player pool.

10. The system of claim 8, wherein assigning the award to at least one member of the first player pool or the second player pool based on the ranking of the first player pool and the second player pool comprises awarding loyalty points to at least one member of the first player pool or the second player pool based on the ranking of the first player pool and the second player pool.

11. The system of claim 8, wherein assigning the award to at least one member of the first player pool or the second player pool based on the ranking of the first player pool and the second player pool comprises awarding gaming venue services to at least one member of the first player pool or the second player pool based on the ranking of the first player pool and the second player pool.

12. The system of claim 8, wherein assigning the award to at least one member of the first player pool or the second player pool based on the ranking of the first player pool and the second player pool comprises assigning an award to one member of the first player pool or the second player pool based on the ranking of the first player pool and the second player pool.

13. The system of claim 8, wherein assigning the award to at least one member of the first player pool or the second player pool based on the ranking of the first player pool and the second player pool comprises assigning an award to each member of the first player pool or the second player pool based on the ranking of the first player pool and the second player pool.

14. The system of claim 8, wherein the award is fixed at the initiation of the first player pool and the second player pool.

15. The system of claim 8, wherein the award is variable during the monitoring of the gaming activity of the plurality of members of the first player pool and the monitoring of the gaming activity of the plurality of members of the second player pool.

16. The system of claim 8, wherein the award is a contribution to a charity.

17. The system of claim 8, wherein the charity is selected by at least one member of the first player pool or the second player pool.

18. A non-transitory, computer-readable medium comprising a set of instructions stored therein which, when executed by a processor, causes the processor to:
monitor gaming activity of a plurality of members of a first player pool of the plurality of player pools;
monitor gaming activity of a plurality of members of a second player pool of the plurality of player pools;
rank the first player pool and the second player pool based on the monitored gaming activity of the plurality of members of the first player pool and the monitored gaming activity of the plurality of members of the second player pool;
detect an occurrence of a pre-defined event; and
in response to detecting the occurrence of the pre-defined event, assign an award to at least one member of the first player pool or the second player pool based on the ranking of the first player pool and the second player pool.

19. The non-transitory, computer-readable medium of claim 18, wherein the instructions further cause the processor to send an electronic message promoting gaming activity to mobile devices of the plurality of members of the first player pool and the plurality of members of the second player pool.

20. The non-transitory, computer-readable medium of claim 18, wherein the instructions further cause the processor to monitor gaming activity of a member of the first player pool prior to assigning the member to the first player pool and wherein the member is assigned to the first player pool in response to the monitored gaming activity of the member exceeding a pre-determined amount.
